(19) United States
(12) Patent Application Publication
(10) Pub. No.: US 2015/0317175 A1
(43) Pub. Date: Nov. 5, 2015

(54) VIRTUAL MACHINE SYNCHRONIZATION SYSTEM

(71) Applicant: HITACHI SYSTEMS, LTD., Tokyo (JP)

(72) Inventors: Naoki Tada, Shinagawa-ku, Tokyo (JP); Mineyuki Tamura, Shinagawa-ku, Tokyo (JP)

(21) Appl. No.: 14/443,500

(22) PCT Filed: Nov. 19, 2012
(86) PCT No.: PCT/JP2013/079943

§ 371 Date: May 18, 2015

(51) Int. Cl. G06F 9/455; H04L 29/08

(52) U.S. Cl. CPC G06F 9/45558; H04L 67/1095; G06F 2009/4557; G06F 2009/45595

(57) ABSTRACT

A virtual machine synchronization system for continually synchronizing, when an image file in a primary virtual machine is updated, an image file of a standby virtual machine with a difference from the image file before an update. A representative embodiment of the present invention includes: a management server; a primary agent which acquires a difference when an image file of a primary virtual machine is updated, and transmits the difference to the management server; and a standby agent which acquires, from the management server, a difference to be synchronized with an image file of a standby virtual machine, and synchronizes with the image file of the standby virtual machine. When the difference is received from the primary agent, the management server registers the difference in a primary machine condition table, and when a request for the difference to be synchronized with the image file of the standby virtual machine is received from the standby agent, the management server acquires the difference which is recorded in the primary machine condition table and transmits the difference to the standby agent.

### CROSS REFERENCE TO RELATED APPLICATIONS

This application is entitled to the benefit of and incorporates by reference subject matter disclosed in International Patent Application No. PCT/JP2012/079943 filed on Nov. 19, 2012.

### TECHNICAL FIELD

The present invention relates to a technique for managing a virtual machine, and especially relates to a technique effectively applied to a virtual machine synchronization system provided with primary and standby virtual machines to synchronize a content of the primary machine with the standby machine.

### BACKGROUND ART

For example, when a cloud computing environment is constructed and operated in a data center etc., a plurality of server devices need to be constructed and operated. In that case, a device, such as a server, is constructed as a virtual machine using a hypervisor for realizing a virtual machine which is one of the computer virtual techniques. In such an environment, when the virtual machine is under maintenance or in a failure condition, etc., work such as maintenance may be conducted after the target virtual machine is instantaneously shifted to the other hypervisor to continue service using what is called live migration.

However, not all virtual machines have a capability of live migration, and there are also environments where migration by live migration may not be conducted. In such an environment, to improve the reliability of the system including virtual machines, a standby virtual machine is created for the target virtual machine (primary machine) and kept switchable.

As a technique related to that, Japanese Patent Application Laid-Open Publication No. 2007-148839, for example, discloses a technique of including a plurality of physical servers in which a plurality of virtual servers operate; means provided with a single standby server for detecting the virtual server in operation; means for switching the association between a startup disk of a virtual mechanism to control the virtual server and the physical server. The technique reconnects the startup disk of the virtual mechanism to an alternate server at the time of a physical server failure, and automatically starts the virtual server operating in the failure condition in order to improve reliability of the virtualized server environment with low cost.

Moreover, Japanese Patent Application Laid-Open Publication No. 2010-102414 discloses a technique of including a configuration information storage for storing configuration information about operational system of a virtual system; a first virtual machine image storing part for storing the virtual machine image for the operational system of the virtual system; a configuration change information storing part for storing configuration change information which is configuration information of a difference between the operational system and a test system of the virtual system; a second virtual machine image storing part for storing the virtual machine image about the structure of the difference between the operational system and the test system of the virtual machine; and a control part, so that switching between the operational system and the test system is smoothly conducted.

### SUMMARY OF THE INVENTION

When the primary and standby system configuration is used in an environment where live migration may not be conducted, the standby virtual machine is synchronized so that the content and condition (for example, versions of patches and anti-virus software etc.) are the same as that of the primary virtual machine; therefore, the standby virtual machine may be kept in operation although there is no need to be in operation from the viewpoint of operating the whole system. Therefore, there has been a problem that resources (CPU, memory, storage, etc.) are wastefully assigned to the standby virtual machine, making effective utilization of the hypervisor's resource impossible.

Moreover, with the technique disclosed in Japanese Patent Application Laid-Open Publication No. 2007-148839, for example, although resources may be efficiently utilized, controlling synchronization of each of the plurality of virtual machines constructed on the hypervisor may be difficult. Moreover, with a technique disclosed in Japanese Patent Application Laid-Open Publication No. 2010-102414, for example, switching is conducted from the test system to the operational system based on difference information of the structure of each server between the operational system and the test system. For example, when the operational system is in actual operation and the image file of the virtual machine continuously changes, continuously reflecting and synchronizing its change (difference) to the test system is not taken into consideration. That is, synchronizing the image file of the primary virtual machine in operation with the standby virtual machine in real time is not taken into consideration.

Therefore, it is an object of the present invention to provide a virtual machine synchronization system, when the image file of the primary virtual machine is updated, the difference from the image file before an update is continuously synchronized with the image file of the standby virtual machine in order to synchronize the content and condition of the standby virtual machine with those of the primary virtual machine without keeping the standby virtual machine in operation. The above and other objects and novel characteristics of the present invention will be apparent from the description of the present specification and the accompanying drawings.

The following is a brief description of an outline of the typical invention disclosed in the present application.

A virtual machine synchronization system according to a typical embodiment of the present invention is a virtual machine synchronization system for synchronizing a content of an image file of a first virtual machine operating in a first hypervisor with an image file of a second virtual machine operating as a standby machine of the first virtual machine on a second hypervisor; and includes the following features.

That is, the virtual machine synchronization system includes a management server which is connectable to the first hypervisor and the second hypervisor via a network; a first monitoring part which operates in the first hypervisor, and when the image file of the first virtual machine is updated, which acquires a difference from the image file before an update and transmits the difference to the management server; a second monitoring part which operates in the second hypervisor, and which acquires the difference to be synchronized with the image file of the second virtual machine from the management server, and synchronizes the difference with the image file of the second virtual machine, and has such a feature that, when the difference is received from the first monitoring part, the management server registers the difference in a first recording part, and when a request for the difference to be synchronized with the image file of the second virtual machine is received from the second monitoring part, the difference recorded in the first recording part is acquired and transmitted to the second monitoring part.

Among the inventions disclosed in the application, the advantageous effects obtained by the representatives will be briefly explained as below.

That is, according to a typical embodiment of the present invention, when the image file of the primary virtual machine is updated, the difference from the image file before an update is continuously synchronized with the image file of the standby virtual machine in order to synchronize the content and condition of the primary virtual machine with those of the standby virtual machine without needing to keep the standby virtual machine in operation. Thereby, the hypervisor's resource may be effectively utilized and the reliability of the virtual machine may be improved.

### BRIEF DESCRIPTIONS OF THE DRAWINGS

FIG. 1 is a diagram illustrating the outline of an example structure of the virtual machine synchronization system according to one embodiment of the present invention;

FIG. 2 is a diagram illustrating the outline of an example data configuration of a target virtual machine TB according to one embodiment of the present invention;

FIG. 3 is a diagram illustrating the outline of an example data configuration of a standby machine condition TB according to one embodiment of the present invention;

FIG. 4 is a diagram illustrating the outline of an example data configuration of a primary machine condition TB according to one embodiment of the present invention;

FIG. 5 is a diagram illustrating a flow chart illustrating the outline of an example flow of the processes to register into a management server the difference acquired from the primary image file according to one embodiment of the present invention; and

FIG. 6 is a diagram illustrating a flow chart illustrating the outline of the example flow of the processes to synchronize with a corresponding standby image file the content of the difference registered in the management server according to one embodiment of the present invention.

### DETAILED DESCRIPTION

In the following, embodiments of the invention will be explained in detail with reference to the drawings. Note that, in all drawings for explanation of the embodiments, the same members basically dented by the same references and their repetitive explanations will be omitted.

The virtual machine synchronization system according to one embodiment of the present invention, in the cloud computing environment etc. operated in a data center etc., for example, monitors the image file of the primary virtual machine; and when the content is updated, extracts difference information from the content before an update and synchronizes it with the image file of the standby virtual machine via the management server. This allows synchronization of the content of the primary virtual machine with that of the standby virtual machine without needing to keep the standby virtual machine in operation, and effective utilization of the hypervisor's resource; therefore, raising the accumulation rate of the virtual machine and greatly reducing the cost.

Since the synchronization of the difference information of the virtual machine image file may be conducted in real time, the content and condition of the standby virtual machine may be maintained the same as those of the primary virtual machine. Moreover, a synchronization failure is detected by tracking whether the synchronization of the difference information is correctly conducted in the standby machine and a reliable synchronization is conducted by retrying. Thereby, availability and reliability may be improved.

<System Configuration>

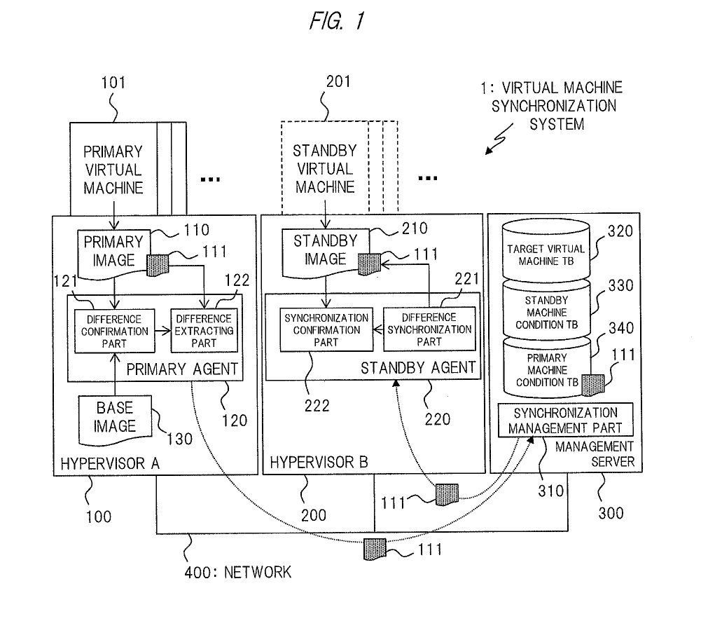

FIG. 1 is a diagram illustrating the outline of an example structure of the virtual machine synchronization system according to one embodiment of the present invention. The virtual machine synchronization system 1 is configured to communicatively connect a plurality of hypervisors (in the example of FIG. 1, two hypervisors: a hypervisor A (100) and a hypervisor B (200)) to a management server 300 via a network 400, such as LAN (Local Area Network). Existing hypervisor products etc. available from a vendor etc. may be suitably utilized as each hypervisor of the primary machine/standby machine.

In the example of FIG. 1, under the control of the hypervisors A (100), one or more (types of) primary virtual machines 101 are in operation, and on the hypervisor A (100), a primary agent (monitoring part) 120 implemented by a software program or a hardware designed with an integrated circuit is in operation.

The primary agent 120, for example, further has each part, such as a difference confirmation part 121 and a difference extracting part 122. The difference confirmation part 121 has the capability to confirm the existence or non-existence of difference (update) between a primary image 110 which is a current image file of the primary virtual machine 101 in operation, and a base image 130 holding the content of the latest image file of the primary virtual machine 101. For example, an existing method of comparing the file sizes between the primary image 110 and the base image 130 may be suitably utilized. This process is conducted based on periodical instruction from the primary agent 120, for example.

The difference extracting part 122 has the capability to extract data of difference as a difference 111 when the difference confirmation part 121 determines that there is a difference. For example, an existing method of comparing the primary image 110 and the base image 130 bit by bit to extract difference may be suitably utilized. The extracted difference 111 is transmitted to the management server 300 via the network 400, after attaching version information and information including the date of acquisition. The format of the version information is not particularly limited as long as the difference 111 may be uniquely identified.

Under the control of the hypervisor B (200), one or more (types of) standby virtual machines 201 are in operable condition (the standby virtual machine 201 does not need to be in operation under normal conditions). In addition, each of these standby virtual machines 201 is a virtual machine as a standby machine corresponding to primary virtual machine 101 operating on the hypervisor A (100). On the hypervisor B (200), in addition, a standby agent (monitoring part) 220 implemented by a software program or a hardware designed with an integrated circuit is in operation.

The standby agent 220 further has each part, such as a difference synchronization part 221 and a synchronization confirmation part 222, for example. The difference synchronization part 221 has the capability to inquire the management server 300 about existence or non-existence of the difference 111 to be synchronized with a standby image 210 which is a virtual machine image file to be used in order to start the standby virtual machine 201, and when there is the difference 111 to be synchronized, acquire the difference, and apply this to the standby image 210 to be synchronized therewith. An existing method may be suitably utilized about application of the difference 111 to the standby image 210.

The synchronization confirmation part 222 has the capability to check the result when the difference 111 is applied by the difference synchronization part 221, and confirm whether such application is correctly conducted and synchronization is complete. When correctly synchronized, the fact is reported to the management server 300, while when not correctly synchronized, after suitable time interval, synchronization is tried again by making the difference synchronization part 221 to retry synchronization of the difference 111, for example. When synchronization is not correctly completed after a certain number of retries, error processing is conducted by reporting the fact to the management server 300, for example. Various existing methods may be suitably utilized as a determination method of whether the synchronization is correctly conducted, including for example, check of result codes when applying the difference 111 in the difference synchronization part 221, and consistency verification of data of the standby image 210.

Although the primary machine and the standby machine are distinguished in the example of FIG. 1, when a process is switched from the primary virtual machine 101 to the standby virtual machine 201, the standby virtual machine 201 operates as a primary machine thereafter. Therefore, each hypervisor may be configured to have both the primary agent 120 and the standby agent 220 so that both the hypervisor A (100) and the hypervisor B (200) may operate as either the primary machine or the standby machine. Alternatively, each hypervisor may be configured to have an agent having the capability of both the primary agent 120 and the standby agent 220.

The management server 300 is a server device to maintain and manage the content of difference 111 in the primary image 110 of the primary virtual machine 101, in addition to manage the status of synchronization for standby image 210 of standby virtual machine 201 thereof. The management server 300 may be configured as a virtual machine. The management server 300, for example, includes an OS and DBMS (DataBase Management System) not illustrated, a synchronization management part 310 implemented by a software program etc. operating on middleware, such as a Web server program. Moreover, the management server 300 includes tables: a target virtual machine table (TB) 320 implemented with a data base, a file table, etc., a standby machine condition TB 330, and a primary machine condition TB 340.

The synchronization management part 310 has the capability to maintain the content of the difference 111 transmitted from the primary agent 120 of the hypervisor A (100) in the primary machine condition TB 340, confirm existence or non-existence of the difference 111 to be synchronized with respect to an inquiry from standby agent 220 of hypervisors B (200), and when the difference 111 exists, acquire this from the primary machine condition TB 340 and transmit to the standby agent 220.

<Data Configuration>

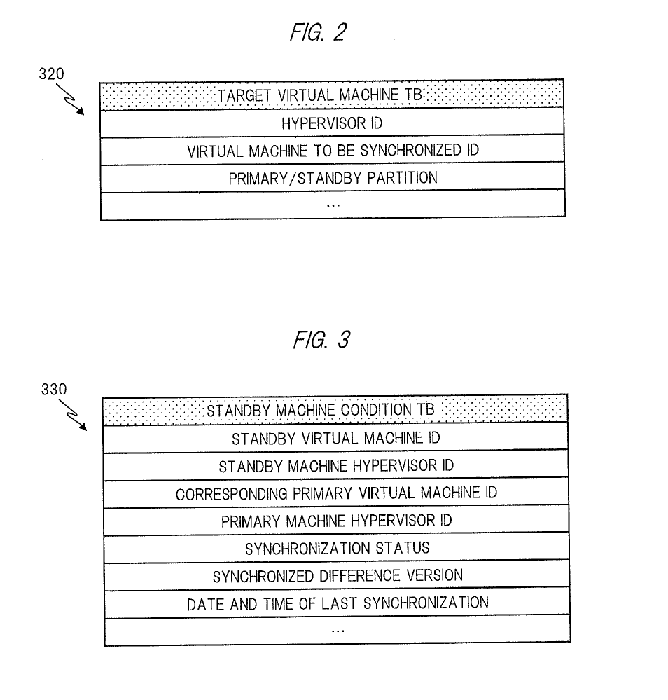

Hereinafter, data configuration of each table in the management server 300 will be described. FIG. 2 is a diagram illustrating the outline of an example data configuration of the target virtual machine TB 320. The target virtual machine TB 320 is, among a plurality of virtual machines operating on each hypervisor, a table maintaining information on the virtual machine whose virtual machine image file is synchronized between the primary machine and the standby machine, and includes fields, such as a hypervisor ID, a virtual machine to be synchronized ID, and a primary/standby partition.

The field of the hypervisor ID maintains ID information to uniquely identify the hypervisor in which the target virtual machine operates. As long as uniquely identifiable, the ID information may be a sequence number, a host name, an IP address, etc. The field of the virtual machine to be synchronized ID maintains ID information to uniquely identify the virtual machine to be synchronized. The ID information may be information uniquely identifiable at the whole system, or may be information uniquely identifiable within the hypervisor. The field of primary/standby partition maintains information, including code value etc. to identify whether the target virtual machine is a primary machine or a standby machine. The value of the field is updated and the target hypervisor and agent refer to the value when a process is switched from the primary machine to the standby machine, so that whether to operate as a primary machine or as a standby machine may be determined.

FIG. 3 is a diagram illustrating the outline of an example data configuration of the standby machine condition TB 330. The standby machine condition TB 330 is a table maintaining information including a synchronization situation of difference 111 about each standby virtual machine 201, and includes fields, such as, a standby virtual machine ID, a standby machine hypervisor ID, a corresponding primary virtual machine ID, a primary machine hypervisor ID, a synchronization status, a synchronized difference version, and the date and time of the last synchronization.

Each field of the standby virtual machine ID and the standby machine hypervisor ID maintains ID information to uniquely identify the target standby virtual machine 201 and the hypervisor B (200) in which the target standby virtual machine 201 operates, respectively. Each field of the corresponding primary virtual machine ID and the primary machine hypervisor ID maintains ID information to uniquely identify the primary virtual machine 101 corresponding to the target standby virtual machine 201 and the hypervisor A (100) in which the primary virtual machine 101 operates, respectively.

The field of the synchronization status maintains code value etc. to indicate the situation of synchronization to the standby image 210 of the difference 111 in the target standby virtual machine 201. Types of situations may include “successful synchronization,” “in synchronization,” and “failed synchronization” for example. At this time, when the synchronization management part 310 of the management server 300 extracts the difference 111 and transmits based on a request from the standby agent 220, the situation shall be “in synchronization,” and when notification of synchronization completion is received from the standby agent 220, the situation shall be “successful synchronization.” Moreover, when notification of a synchronization failure is received from the standby agent 220, the situation shall be “failed synchronization.”

The field of the synchronized difference version maintains version information to uniquely identify the difference 111 which has been synchronized to the target standby virtual machine 201. This value is updated by the value of the version information of the synchronized difference 111 when the synchronization management part 310 receives the notification of synchronization completion from the standby agent 220. The field of the date and time of the last synchronization maintains time stamp information of when synchronization of the difference 111 last successfully completed in the standby agent 220. This value is also updated when the synchronization management part 310 receives the notification of synchronization completion from the standby agent 220.

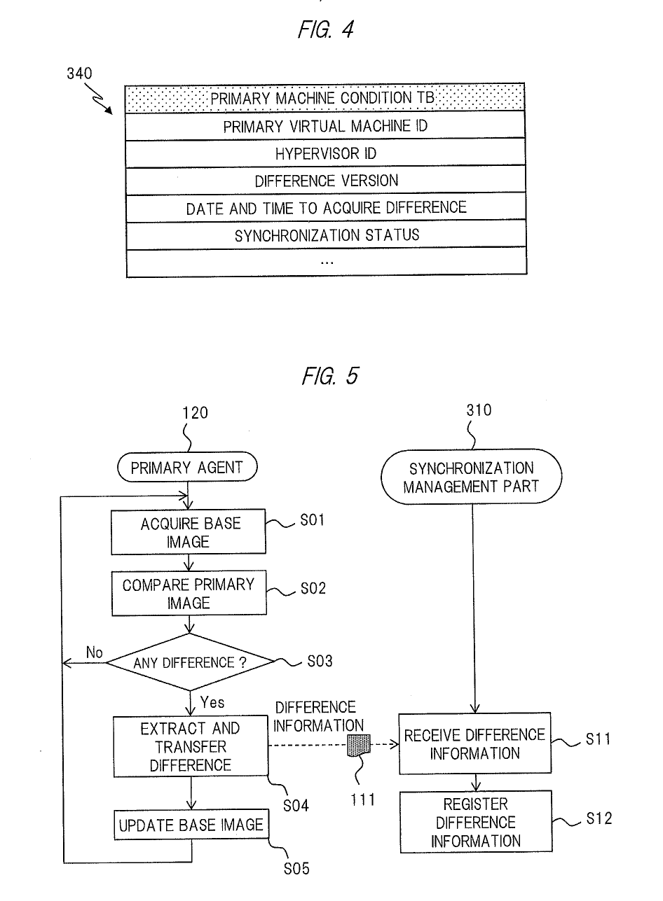

FIG. 4 is a diagram illustrating the outline of an example data configuration of primary machine condition TB 340. The primary machine condition TB 340 is a table maintaining information including the synchronization situation of the difference 111 extracted from the primary image 110 about each primary virtual machine 101, and includes fields, such as, a primary virtual machine ID, a hypervisor ID, a difference version, the date and time to acquire difference, and a synchronization status.

Each field of the primary virtual machine ID and the hypervisor ID maintains ID information to uniquely identify the target primary virtual machine 101 and the hypervisor A (100) in which the target primary virtual machine 101 operates, respectively. Each field of the difference version and the date and time to acquire difference maintains version information to uniquely identify the difference 111 obtained from the primary image 110 of the target primary virtual machine 101 and information on the time stamp to acquire the difference 111, respectively.

The field of the synchronization status maintains the code value etc. to indicate the situation of the synchronization to the standby image 210 of the corresponding standby virtual machine 201 about the target difference 111. Types of situation may include “not synchronized” and “synchronization finished”, for example. At this time, when the synchronization management part 310 of the management server 300 receives the difference 111 from the primary agent 120, the entry shall be registered as “not synchronized”, and when notification of synchronization completion is received from the standby agent 220, the entry shall be registered as “synchronization finished.”

By keeping the history record of several versions of the difference 111 obtained from the primary virtual machine 101, and by performing generation control to allow restoration of the virtual machine image file to the condition of any version, the virtual machine synchronization system 1 may be utilized as a backup system for the primary virtual machine 101.

In addition, the data configuration (field) of each table illustrated in the above-mentioned FIGS. 2 to 4 is merely one example, and as long as the structure may maintain and manage similar type of data, other table configurations and data configurations may be used.

<Process Flow>

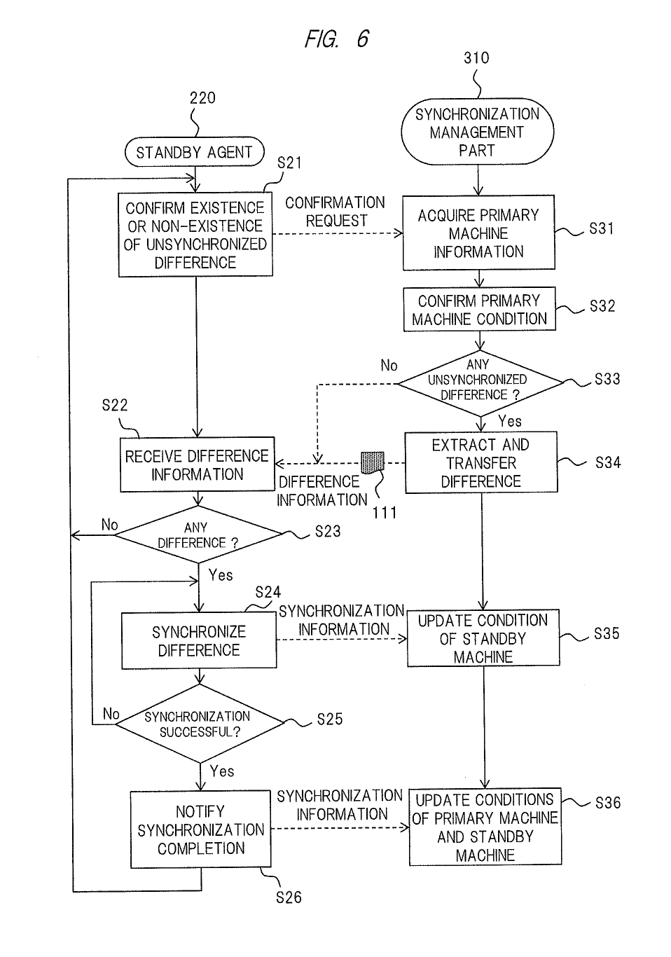

FIG. 5 and FIG. 6 explain the process flow to continuously synchronize the content of the primary image 110 of the primary virtual machine 101 with the standby image 210 of the standby virtual machine 201. FIG. 5 is a flow chart illustrating the outline of an example flow of the process to register the difference 111 acquired from the primary image 110 into the management server 300. The primary agent 120 of the hypervisor A (100) periodically acquires the base image 130 by the difference confirmation part 121 about each primary virtual machine 101 operating on the hypervisor A (100) (S01), and compares with the current primary image 110 (S02).

When the existence or non-existence of difference is judged based on the result of comparison in step S02 (S03), and no difference is found, there is no difference 111 to be synchronized with the standby virtual machine 201; therefore, the flow goes back to step S01 to repeat the process to periodically confirm the existence or non-existence of difference. When there is difference, the difference extracting part 122 extracts the difference 111 from the primary image 110, and transmits the difference information containing the difference 111 to the synchronization management part 310 of the management server 300 (S04). The difference information includes, in addition to the difference 111, information such as the version and date and time of acquisition, an ID of the target primary virtual machine 101, and an ID of the hypervisor A (100). Then, the base image 130 is overwritten and updated with the content of the current primary image 110 (S05), and the flow goes back to step S01 to repeat the periodical process.

On the other hand, when the difference information including the difference 111 is received from primary agent 120 (S11), the synchronization management part 310 of the management server 300 registers the content including difference 111 into the primary machine condition TB 340 (S12). At this time, the value such as “not synchronized” indicating that the difference 111 has not been synchronized with the standby image 210 of the standby virtual machine 201 is set to the field of the synchronization status of the primary machine condition TB 340.

In addition, in the example of FIG. 5, various kinds of methods may be used regarding how the primary agent 120 specifies the target (primary virtual machine 101) to confirm the existence or non-existence of the difference 111 of the virtual machine image file among the virtual machines operating on the hypervisor A (100). For example, the configuration may be used to inquire the registered content of the target virtual machine TB 320 to the management server 300 in order to acquire the list of IDs of the virtual machines to confirm the existence or non-existence of the difference 111 by itself. Moreover, the configuration may be such that each hypervisor has a table maintaining the same content as the part regarding itself among the contents registered in the target virtual machine TB 320 and refers thereto.

FIG. 6 is a flow chart illustrating the outline about the example flow of the process which synchronizes with the corresponding standby image 210 the content of the difference 111 registered in the management server 300. The standby agent 220 of the hypervisor B (200) inquires of the management server 300 periodically to confirm the existence or non-existence of the unsynchronized difference 111 which should be synchronized with the standby image 210 (S21) with the difference synchronization part 221 etc. for each standby virtual machine 201 which may operate on the hypervisor B (200), and receives difference information from the synchronization management part 310 of the management server 300 as a result (S22). This difference information includes, for example, the content of unsynchronized difference 111 of one or more versions. Moreover, when any unsynchronized difference 111 does not exist, information to indicate the fact is included.

Then, whether any unsynchronized difference 111 is included in the difference information received from the synchronization management part 310 is determined (S23), and when no difference 111 is found, the flow goes back to step S21 to repeat the process to periodically confirm the existence or non-existence of the unsynchronized difference 111 to the management server 300. On the other hand, when the unsynchronized difference 111 exists, the unsynchronized difference 111 is applied to and synchronized with the target standby image 210 (S24). At this time, synchronization information to indicate that synchronization was started is notified to the management server 300.

Then, the synchronization confirmation part 222 determines whether the difference 111 is correctly applied to the standby image 210 and the synchronization is successful (S25), and when the synchronization is not successful, the flow goes back to step S24, and after a fixed time, the synchronous process of the difference 111 is retried. If the result is unsuccessful after the predetermined number of retries, synchronization information (not illustrated) to indicate that the synchronization was unsuccessful may be notified to the management server 300. When the synchronization is successful, information regarding the fact and the synchronization is notified to the management server 300 (S26), and the flow goes back to step S21 to repeat the periodical process.

On the other hand, when the synchronization management part 310 of the management server 300 receives a confirmation request of the existence or non-existence of the unsynchronized difference 111 from the standby agent 220, based on information on an ID of the standby virtual machine 201 of the target included in the confirmation request, the synchronization management part 310 refers to the standby machine condition TB 330 and acquires an ID of a corresponding primary virtual machine 101 and an ID of the hypervisor A (100) in which primary virtual machine 101 operates (S31). Moreover, by referring to the primary machine condition TB 340 and confirming the registered status of the difference 111 in the target primary virtual machine 101 (S32) based on this information, the existence or non-existence of the difference 111 with the synchronization status “not synchronized” is determined (S33).

In step S33, when any unsynchronized difference 111 does not exist, difference information to indicate the fact is responded to the standby agent 220. When unsynchronized difference 111 exists, difference information thereof is extracted from the primary machine condition TB 340 and is responded to the standby agent 220 (S34).

Then, when synchronization information is received to indicate that the synchronization was started from the standby agent 220, the synchronization status of the entry of the target standby virtual machine 201 of the standby machine condition TB 330 is updated to be “in synchronization” based on the content (S35). In addition, when synchronization information to indicate synchronization completion is received from the standby agent 220, the synchronization status of the entry of the target difference information of the primary machine condition TB 340 is updated to be “synchronization finished” based on the content, and the synchronization status of the entry of the target standby virtual machine 201 of the standby machine condition TB 330 is updated to be “successful synchronization” (S36). When the synchronization information (not illustrated) is received from the standby agent 220 to indicate that the synchronization is unsuccessful, the synchronization status of the entry of the target standby virtual machine 201 of the standby machine condition TB 330 is updated to be “failed synchronization.”

Also in the example of FIG. 6, in the same manner as the example of FIG. 5, in order to specify the target (standby virtual machine 201) with which the standby agent 220 synchronizes the content of the difference 111 among the virtual machines which may operate on the hypervisor B (200), the configuration may be used, for example, to inquire the registered content of the target virtual machine TB 320 to the management server 300 and acquire the list of IDs of the virtual machines to be the target to synchronize the content of the difference 111 by itself. Moreover, the configuration may be such that each hypervisor has a table maintaining the same content as the part regarding itself among the contents registered in the target virtual machine TB 320 and refers thereto.

As described above, according to the virtual machine synchronization system 1 of the first embodiment of the present invention, in the cloud computing environment etc. operated in a data center etc., the primary image 110 of the primary virtual machine 101 is monitored, and when the content is updated, the difference 111 from the content before an update and is extracted and synchronized with the standby image 210 of standby virtual machine 201 via the management server 300. This allows synchronization of the content of the primary virtual machine 101 with that of the standby virtual machine 201 without needing to keep the standby virtual machine 201 in operation, and effective utilization of the hypervisor B (200)'s resource; therefore, raising the accumulation rate of the virtual machine and greatly reducing the cost.

Moreover, since the synchronization of the difference 111 may be conducted in real time, the content and condition of the standby virtual machine 201 may be maintained the same as those of the primary virtual machine 101. Moreover, a synchronization failure is detected by tracking whether the synchronization of the difference 111 is correctly conducted in the standby image 210 and a reliable synchronization is conducted by retrying. Thereby, availability and reliability may be improved.

In the foregoing, the invention made by the inventors of the present invention has been concretely described based on the embodiments. However, it is needless to say that the present invention is not limited to the foregoing embodiments and various modifications and alterations can be made within the scope of the present invention. For example, the above embodiments are those described in detail in order to better illustrate the invention and are not intended to be limited to necessarily provide all the configurations described. Part of the configuration of a certain embodiment can be replaced by the configuration of another embodiment. Moreover, part of the configuration of the embodiment can be subjected to addition/deletion/replacement of other configurations.

For example, although the difference 111 between the base image 130 and the primary image 110 is confirmed and extracted in the primary agent 120 on the hypervisor A (100) in the above-described embodiment, the configuration may be used so that the content of the base image 130 is maintained in the management server 300, the primary agent 120 transmits the primary image 110 to the management server 300, the management server 300 confirms and extracts the existence or non-existence of the difference 111, and the difference 111 is transmitted to the standby agent 220 in the hypervisor B (200). This allows less utilization of the resource of the hypervisor A (100).

Moreover, for example, in a situation in which the system environment including the hypervisor A (100) and hypervisor B (200) is constructed in data centers, the capability of the management server 300 may be configured to provide service via the Internet for these data centers. This allows, in each data center, to easily improve the reliability of the virtual machine without independently constructing the management server 300. Moreover, for example, by configuring the data center in which the hypervisor A (100) exists, and the data center in which the hypervisor B (200) exists in remote places, a disaster recovery system may be easily constructed.

The present invention is applicable to a virtual machine synchronization system including a primary virtual machine and a standby virtual machine to synchronize the content of the primary machine with that of the standby machine.

While the present invention has been illustrated and described with respect to a particular embodiment thereof, it should be appreciated by those of ordinary skill in the art that various modifications to this invention may be made without departing from the spirit and scope of the present.

What is claimed is:

1. A virtual machine synchronization system for synchronizing a content of an image file of a first virtual machine operating in a first hypervisor with an image file of a second virtual machine operating as a standby machine of the first virtual machine on a second hypervisor; comprising:
a management server which is connectable to the first hypervisor and the second hypervisor via a network;
a first monitoring part which operates in the first hypervisor, and when the image file of the first virtual machine is updated, which acquires a difference from the image file before an update and transmits the difference to the management server; and
a second monitoring part which operates in the second hypervisor, and which acquires the difference to be synchronized with the image file of the second virtual machine from the management server, and synchronizes the difference with the image file of the second virtual machine,
wherein, when the difference is received from the first monitoring part, the management server registers the difference in a first recording part, and when a request for the difference to be synchronized with the image file of the second virtual machine is received from the second monitoring part, the difference recorded in the first recording part is acquired and transmitted to the second monitoring part.

2. The virtual machine synchronization system according to claim 1,
wherein the second monitoring part determines whether or not synchronization is successful upon synchronizing the difference acquired from the management server with the image file of the second virtual machine, and when synchronization is not successful, the synchronization is retried.

3. The virtual machine synchronization system according to claim 1,
wherein the management server registers a value to indicate that synchronization is not conducted as a status about the synchronization of the difference when the difference is received from the first monitoring part and is registered in the first recording part, and when a notification is received from the second monitoring part to indicate that the synchronization of the difference to the image file of the second virtual machine is successful, the status about the synchronization of the difference registered in the first recording part is updated to a value indicating that synchronization is finished.

4. The virtual machine synchronization system according to claim 1,
wherein the management server receives a request for the difference to be synchronized with the image file of the second virtual machine from the second monitoring part, registers a value to indicate that synchronization is in progress as a status about synchronization of the second virtual machine in the second recording part when the difference recorded in the first recording part is acquired and transmitted to the second monitoring part, and when a notification is received from the second monitoring part to indicate that the synchronization of the difference to the image file of the second virtual machine is successful, the status about the synchronization of the second virtual machine registered in the second recording part is updated to a value indicating that synchronization is successfully completed.

5. The virtual machine synchronization system according to claim 1,
wherein, when the management server receives the difference from the first monitoring part and registers this in the first recording part, the management server registers the difference for each different version.

6. The virtual machine synchronization system according to claim 1,
wherein any one or more of the first hypervisor, the second hypervisor, and the management servers operates in a different location.

7. A virtual machine synchronization system for synchronizing a content of an image file of a first virtual machine operating in a first hypervisor with an image file of a second virtual machine operating as a standby machine of the first virtual machine in a second hypervisor; comprising:
a management server which is connectable to the first hypervisor and the second hypervisor via a network;
a first monitoring part which operates in the first hypervisor, and which transmits the image file of the first virtual machine to the management server; and
a second monitoring part which operates in the second hypervisor, and which acquires a difference to be synchronized with the image file of the second virtual machine from the management server, and synchronizes with the image file of the second virtual machine,
wherein, when the image file of the first virtual machine is received from the first monitoring part, and when the image file is updated, the management server acquires a difference from the image file before an update and registers the difference in the first recording part, and when a request for the difference to be synchronized with the image file of the second virtual machine is received from the second monitoring part, the difference recorded in the first recording part is acquired and transmitted to the second monitoring part.
